(19) United States
(12) Patent Application Publication
(10) Pub. No.: US 2013/0240429 A1
(43) Pub. Date: Sep. 19, 2013

(54) FILTER CARTRIDGE PROTECTIVE SLEEVE

(71) Applicants: Thomas Robbins, Pattaya (TH); John Nohren, St. Petersburg, FL (US)

(72) Inventors: Thomas Robbins, Pattaya (TH); John Nohren, St. Petersburg, FL (US)

(21) Appl. No.: 13/418,894

(22) Filed: Mar. 13, 2012

(51) Int. Cl. B01D 35/30

(52) U.S. Cl. 210/232

(57) ABSTRACT

A filter cartridge protective sleeve is provided. The filter cartridge protective sleeve includes a cylindrical body formed of a non-rigid, flexible and resilient silicone material configured to be frictionally retained to a filter cartridge by expanding said body to conform to at least a portion of the filter cartridge. At least one flow opening is formed through the sleeve to permit a flow of water/liquid to the filter cartridge. The sleeve may include indicia elevated from an exterior surface of the body. The indicia and body are integral and formed of the same material.

### FIELD OF THE INVENTION

The present invention relates, generally, to water filters. More particularly, this invention relates to a protective sleeve for a filter cartridge of the type typically used in connection with a sports water bottle for filtering water as a user drinks the water.

### BACKGROUND OF THE INVENTION

Conventional filter cartridge protective sleeves are formed of a rigid plastic material provided in either a screen/mesh form that is integrated with the filter cartridge during manufacture thereof or of a rigid plastic material provided as an external housing that covers the filter cartridge. These conventional filter cartridge protective sleeves provide no means of personalizing the appearance of the filter cartridge according to one's personal desire, are not configurable beyond their initial manufacture to meet specific filter cartridge requirements, and are considered to impede the flow of water/liquid into the filter cartridge. Accordingly, a need exists for an improved filter cartridge protection sleeve, for example in the area of providing a user with the ability to personalize the appearance of the filter cartridge, providing a user with the ability to configure the protective sleeve according to filter cartridge use requirements, and providing a less restrictive water/liquid flow into the filter cartridge.

### SUMMARY OF THE INVENTION

In carrying out principles of the present invention, in accordance with an illustrated representative embodiment thereof, the present invention provides a specially designed filter cartridge protective sleeve which may be operatively associated with a filter cartridge of a conventional sports water bottle to provide for a user a filter cartridge protective sleeve with indicia permitting personalization of the filter cartridge.

In further carrying out the principles of the present invention, in accordance with an illustrated representative embodiment thereof, the present invention provides a specially designed filter cartridge protection sleeve formed of a non-rigid, flexible material that is easily removed and replaced, and which is configurable to the use requirements of a particular filter cartridge. The non-rigid, flexible material construction permits mounting the protective sleeve to various filter cartridge designs, and provides a frictional, sealing engagement between the protective sleeve and the filter cartridge.

In further carrying out the principles of the present invention, in accordance with an illustrated representative embodiment thereof, the present invention provides a specially design filter cartridge protection sleeve formed of a silicone material having a wetting angle that provided a less restrictive water/liquid flow to the filter cartridge.

To achieve these and other advantages, in general, in one aspect, a filter cartridge protective sleeve includes a body formed of a non-rigid, flexible and resilient material configured to be frictionally retained to a filter cartridge by expanding the body to conform to at least a portion of the filter cartridge. The sleeve includes at least one liquid flow opening through the body.

In general, in another aspect, the sleeve includes indicia elevated from an exterior surface of the body, and the indicia and the body are integral and formed of the same material.

In general, in another aspect, the non-rigid, flexible and resilient material is a silicone material.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a perspective, exploded assembly view of a filter cartridge protective sleeve constructed in accordance with the principles of an embodiment of the present invention and a representatively illustrated filter cartridge;

FIG. 2 is a side elevation view of the filter cartridge protective sleeve of FIG. 1 mounted to the filter cartridge;

FIG. 3 is side elevation view a filter cartridge protective sleeve constructed in accordance with the principles of an alternative embodiment of the present invention, showing the filter cartridge sleeve with a single row of water flow openings disposed towards one end of the sleeve;

FIG. 4 is side elevation view a filter cartridge protective sleeve constructed in accordance with the principles of an alternative embodiment of the present invention including raised or elevated indicia; and

FIG. 5 is a top plan view of the filter cartridge protective sleeve of FIG. 4, illustrating indicia raised from the exterior surface of the sleeve.

### DETAILED DESCRIPTION OF THE INVENTION

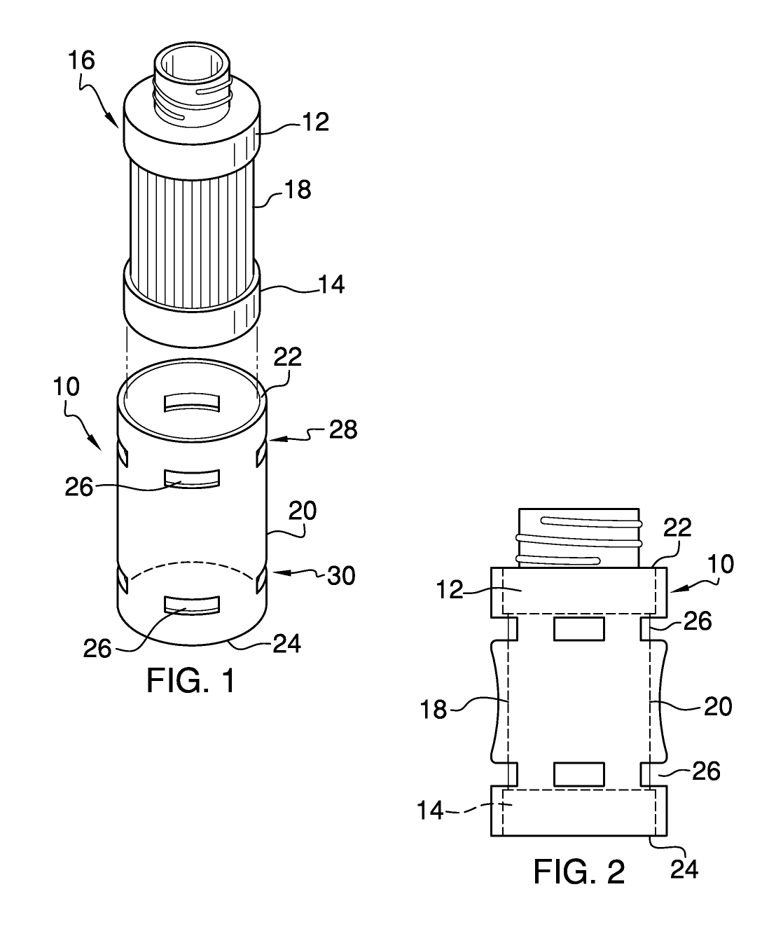

As illustrated in the accompanying FIGS. 1-2, this invention provides a specially designed filter cartridge sleeve 10 which embodies the principles of the present invention. The filter cartridge sleeve 10 is mountable to the top end cap 12 and bottom end cap 14 of a filter cartridge 16 to protect the filter material 18 extending between the top and bottom end caps. Representatively, the filter cartridge 16 is of the type used in connection with a sports water bottle which operates to filter water as the water is drawn from the sports bottle by a user drinking water therefrom.

Filter cartridge sleeve 10 is comprised of a generally elongated, cylindrically shaped body 20 having opposed open ends 22 and 24. Body 20 is formed of a non-rigid, flexible material that is resilient. As a non-limiting example, body 20 may be formed of a silicone material, and more preferably, of a food grade silicone material. The body 20 is sized to have an internal diameter that is less than the external diameter of the end caps 12 and 14 of the filter cartridge such that ends 22 and 24 expand and conform to the diameter of the end caps so as to provide a frictional fit between the filter cartridge 16 sleeve 10 and the filter cartridge and to provide a sealing contact between ends 22 and 24 and end caps 12 and 14, respectively, as best seen in FIG. 2. The filter cartridge sleeve 10 may also adapt shape-wise to neck in slightly when stretched to fit the end caps 22, 24 providing a unique appearance, as seen in FIG. 2.

It is contemplated that in certain instances it may be desirable to affix the body 20 of the sleeve to either or both of the filter end caps 12 and 14 or another suitable structure of the filter cartridge 16 by adhesive, welding or the like.

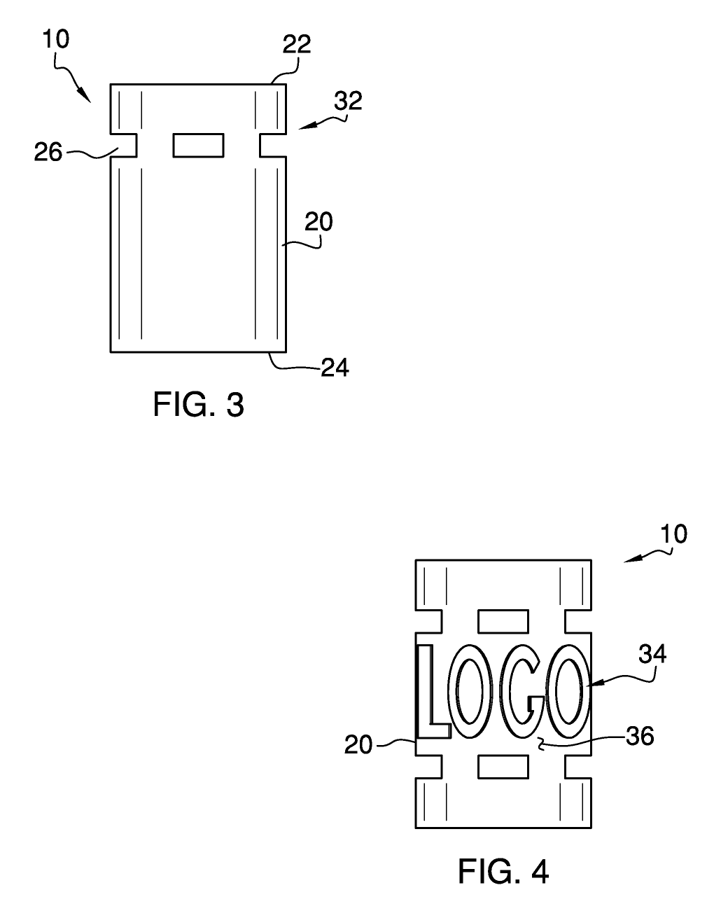

The filter cartridge sleeve 20 further includes openings 26 through the body 20 to permit the flow of water/liquid across the filter cartridge sleeve. In the representative embodiment illustrated in FIGS. 1 and 2, there is an upper circumferential row 28 of openings 26 and a lower circumferential row 30 of openings 26. However, more or less rows of openings 26 may be provided, and further the openings may be provided in various patterns while remaining within the scope of the invention. For example, with reference to FIG. 3, there is illustrated a filter cartridge sleeve 10 comprising a single row 32 of openings 26 disposed towards end 22. In this illustrative embodiment, filter cartridge sleeve 10 may be mounted to a filter cartridge 16 with either the row of openings 32 located towards the top or bottom of the filter cartridge as desired and/or required by the particular function and/or construction of the filter cartridge. That is, a filter cartridge may designed in such a manner that requires an inflow of water at the top of the cartridge, while another filter cartridge may be designed in such a manner that requires an inflow of water at the bottom of the cartridge.

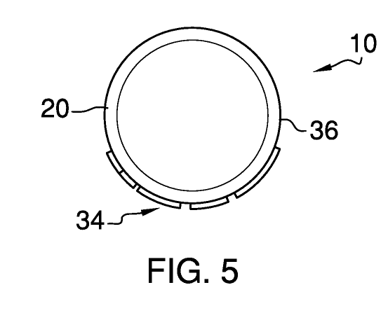

With reference to FIGS. 4 and 5, the filter cartridge sleeve 10 may be provided with various indicia 34 for decorative and/or promotional purpose, and which is generically indicated by the phrase “logo.” The indicia 34 are formed to be raised off the exterior surface 36 body 20 of the filter cartridge sleeve 10. Preferably, the indicia 34 and body 20 are manufactured in a manner such that the indicia and body are formed of the same material and such that the indicia are integral with the body forming a single unitary body. Various portions of the indicia 34 may be of different colors. The preferably food grade silicon material, mentioned above, is an ideal material for use in such a configuration and the manufacture thereof. While not illustrated, the filter cartridge sleeve 10 may be manufactured with or without the indicia by injection molding.

Another advantage to forming the filter cartridge sleeve 10 from silicone is found in the relatively high wetting angle of silicone as compared to the hard plastic material conventionally used to mold or manufacture filter housings. The conventional filter housing formed of hard plastic can retard flow across the filter as a result of the normal boundary layer created with water on a surface with an angle of wetting less than 90 degrees. However, when we employ silicone as the material of choice we have found that the material's natural high angle of wetting exceeding 90 degrees, being hydrophobic, repulsing the water aids rather than inhibits flow.

A number of embodiments of the present invention have been described. Nevertheless, it will be understood that various modifications may be made without departing from the spirit and scope of the invention. Accordingly, other embodiments are within the scope of the following claims.

What is claimed is:

1. A filter cartridge protective sleeve, comprising:
a body formed of a non-rigid, flexible and resilient material configured to be attached to a filter cartridge to protect a filter material of the filter cartridge; and
said sleeve including at least one liquid flow opening through said body.

2. The filter cartridge proactive sleeve of claim 1, wherein said body is configured to be frictionally retained to a filter cartridge by expanding said body to conform to at least a portion of the filter cartridge.

3. The filter cartridge protective sleeve of claim 2, wherein said body is cylindrical-shaped and is open at opposite ends.

4. The filter cartridge protective sleeve of claim 2, wherein said sleeve includes indicia elevated from an exterior surface of said body, and wherein said indicia and said body are integral and formed of the same material.

5. The filter cartridge of claim 4, wherein said indicia includes disparate colored portions.

6. The filter cartridge of claim 2, wherein said material is a silicone material.

7. The filter cartridge of claim 6, wherein said body is cylindrical-shaped and is open at opposite ends.

8. The filter cartridge protective sleeve of claim 6, wherein said sleeve includes indicia elevated from an exterior surface of said body, and wherein said indicia and said body are integral and formed of the same material.

9. The filter cartridge of claim 8, wherein said indicia includes disparate colored portions.

10. A filter cartridge protective sleeve, comprising:
a cylindrical body formed of a non-rigid, flexible and resilient silicone material configured to be frictionally retained to a filter cartridge by expanding said body to conform to at least a portion of the filter cartridge; and
said sleeve including at least one circumferential row of openings.

11. The filter cartridge protective sleeve of claim 10, wherein said at least one circumferential row of openings includes a first circumferential row of openings disposed towards one end of said body, and a second circumferential row of opening disposed towards an opposite end of said body.

12. The filter cartridge protective sleeve of claim 10, wherein said sleeve includes indicia elevated from an exterior surface of said body, and wherein said indicia and said body are integral and formed of the same material.

13. The filter cartridge protective sleeve of claim 12, wherein said indicia includes disparate colored portions.

14. A filter cartridge protective sleeve and filter cartridge assembly, comprising:
a filter cartridge having first and second end caps and a filter material extending between said first and second end caps;
a filter cartridge protective sleeve having a body formed of a non-rigid, flexible and resilient material, and said sleeve including at least open liquid flow opening through said body;
said sleeve mounted to said first and second end caps and covering said filter cartridge; and
wherein said body is expanded to conform to at least a portion of said filter cartridge, and wherein said expansion frictionally retains to said filter cartridge protective sleeve to said filter cartridge.

15. The filter cartridge protective sleeve and filter cartridge assembly of claim 14, wherein said material forming said body is silicone.

16. The filter cartridge protective sleeve and filter cartridge assembly of claim 14, wherein said body is cylindrical-shaped and is open at opposite ends.

17. The filter cartridge protective sleeve and filter cartridge assembly of claim 14, wherein said sleeve includes indicia elevated from an exterior surface of said body, and wherein said indicia and said body are integral and formed of the same material.

18. The filter cartridge protective sleeve and filter cartridge assembly of claim 17, wherein said indicia includes disparate colored portions.

19. The filter cartridge protective sleeve and filter cartridge assembly of claim 14, wherein said body is cylindrical shape and wherein said at least one fluid opening is disposed towards the top of said body, thereby permitting water to enter the top of said protective sleeve when said filter cartridge is attached a bottle top.

20. The filter cartridge protective sleeve and filter cartridge assembly of claim 14, wherein said body is cylindrical shape and wherein said at least one fluid opening is disposed towards the bottom of said body, thereby permitting water to enter the bottom said protective sleeve when said filter cartridge is attached an end of a straw.
